(19) United States
(12) Patent Application Publication
(10) Pub. No.: US 2014/0015729 A1
(43) Pub. Date: Jan. 16, 2014

(54) ANTENNA DEVICE

(71) Applicants: Hiroyuki Uejima, Ishikawa (JP); Yoshio Koyanagi, Kanagawa (JP); Suguru Kojima, Kanagawa (JP); Takanori Hirobe, Ishikawa (JP); Kouta Aoki, Kanagawa (JP); Masao OotaniI, Kanagawa (JP)

(72) Inventors: Hiroyuki Uejima, Ishikawa (JP); Yoshio Koyanagi, Kanagawa (JP); Suguru Kojima, Kanagawa (JP); Takanori Hirobe, Ishikawa (JP); Kouta Aoki, Kanagawa (JP); Masao OotaniI, Kanagawa (JP)

(73) Assignee: PANASONIC CORPORATION, Osaka (JP)

(21) Appl. No.: 14/007,896

(22) PCT Filed: Jun. 6, 2012
(86) PCT No.: PCT/JP2012/003714

§ 371 Date: Sep. 26, 2013

(51) Int. Cl. H01Q 9/14; H01Q 1/50

(52) U.S. Cl. CPC H01Q 9/145; H01Q 1/50
USPC 343/850

(57) ABSTRACT

A first antenna element 102, a second antenna element 103, and a MEMS (micro-electromechanical system) switch 104 are provided, and a feeding point 110 is provided at one end of the first antenna element 102. The other end 113 of the first antenna element 102 is connected to a first terminal 106 of the MEMS switch 104, and one end 114 of the second antenna element 103 is connected to a second terminal 107 of the MEMS switch 104. The one end of the first antenna element 102 is grounded to a ground pattern 101 via an inductor 115, and a ground terminal 105 of the MEMS switch 104 is connected to the other end 113 of the first antenna element 102.

### TECHNICAL FIELD

The present invention relates to a multi-band antenna device whose resonance frequency can be switched by varying the electrical length of an antenna element using a switch(es).

### BACKGROUND ART

Among the conventional antenna devices of the above kind are ones disclosed in Patent documents 1, 2, and 3.

Patent document 1 discloses the following technique. An antenna is provided with a feeding point and plural grounding points, and plural grounding point switches are provided which connect or disconnect the respective grounding points to or from the ground. The resonance frequency is adjusted by switching the grounding points by selecting among the grounding point switch means and performing switching operations.

Patent document 2 discloses a technique relating to an antenna device which is equipped with plural MEMS (micro-electromechanical system) switches. The operating frequency is varied by varying the size and shape of an antenna using the plural MEMS switches and plural minute patch conductors.

Patent document 3 discloses the following technique. An optical signal processing unit and a switch control circuit which are provided adjacent to each other in a switch unit on an antenna element are connected to each other by an optical waveguide, and a control signal to the switch unit is transmitted by an optical communication. The physical length of the antenna element is varied by on/off-controlling the switch unit, whereby the frequency characteristic is varied.

### PRIOR ART DOCUMENTS

### Patent Documents

Patent document 1: JP-A-2002-261533

Patent document 1: JP-A-2007-142721

Patent document 1: JP-A-2007-174017

### SUMMARY OF THE INVENTION

### Problems to be Solved by the Invention

However, in the above-described conventional configurations, in the case where switch ground patterns which are connected to the switch ground terminals are close to the antenna element, the antenna performance may be degraded; for example, the bandwidth of the antenna may be narrowed or radiation resistance may be reduced to lower the radiation efficiency.

For example, whereas the techniques of Patent documents 1 and 2 are suitable for inverted-F antennas and patch antennas, when they are applied to a case that the electrical length of an monopole antenna element is varied by inserting the switches in the antenna element in series to it, switch ground patterns are located close to the antenna element, as a result of which the antenna performance may be degraded. In the technique of Patent document 3, whereas degradation of the antenna performance due to signals for controlling the switches can be avoided, the configuration is complex and the cost is high. There is no disclosure relating to switch ground patterns that are connected to the ground terminals of the switches.

An object of the present invention is to provide an antenna device which is free of degradation of the antenna performance due to a structure that switch ground patterns connected switch ground terminals are close to an antenna element and in which the resonance frequency can be switched by varying the electrical length of an antenna element.

### Means for Solving the Problems

To solve the problems of the prior art, an antenna device according to the invention is configured so as to include a circuit board having a ground pattern; a first antenna element and a second antenna element which are disposed so as to be spaced from the ground pattern by prescribed intervals; and a first switch which has a ground terminal, a first terminal, and a second terminal and connects or disconnects the first terminal and the second terminal to or from each other, wherein a feeding point is provided at one end of the first antenna element, and the other end of the first antenna element is connected to the first terminal of the first switch; one end of the second antenna element is connected to the second terminal of the first switch; and the one end of the first antenna element is grounded to the ground pattern of the circuit board via an inductor. and the ground terminal of the first switch is connected to the other end of the first antenna element. In this antenna device, since the first antenna element also serves as the switch ground pattern which is connected to the ground terminal of the switch, two resonance frequencies can be obtained by varying the electrical length of the antenna element without degrading the antenna performance.

Another antenna device according to the invention is configured so as to include a circuit board having a ground pattern; a first antenna element and plural second antenna elements which are disposed so as to be spaced from the ground pattern by prescribed intervals, the plural second antenna elements having different electrical lengths to each other; and a first switch which has a ground terminal, a first terminal, and plural second terminals and connects or disconnects the first terminal and each of the second terminals to or from each other, wherein a feeding point is provided at one end of the first antenna element, and the other end of the first antenna element is connected to the first terminal of the first switch; one ends of the second antenna elements are connected to the respective second terminals of the first switch; and the one end of the first antenna element is grounded to the ground pattern of the circuit board via an inductor, and the ground terminal of the first switch is connected to the other end of the first antenna element. This antenna device can provide three or more resonance frequencies because it is equipped with the plural second antenna elements.

Another antenna device according to the invention is configured so as to include a circuit board having a ground pattern; a first antenna element and a second antenna element which are disposed so as to be spaced from the ground pattern by prescribed intervals; and a first switch which has a ground terminal, a first terminal, and plural second terminals and connects or disconnects the first terminal and each of the second terminals to or from each other, wherein a feeding point is provided at one end of the first antenna element, and the other end of the first antenna element is connected to the first terminal of the first switch; one of the second terminals of the first switch is connected to one end of the second antenna element, and at least one of the other second terminals is connected to the one end of the second antenna element via a reactance element; and the one end of the first antenna element is grounded to the ground pattern of the circuit board via an inductor, and the ground terminal of the first switch is connected to the other end of the first antenna element. This antenna device can provide three or more resonance frequencies even with the single antenna element.

A further antenna device according to the invention is configured so as to include a circuit board having a ground pattern; a first antenna element and a second antenna element which are disposed so as to be spaced from the ground pattern by prescribed intervals: and a first switch which has a ground terminal, a first terminal, and plural second terminals and connects or disconnects the first terminal and each of the second terminals to or from each other, wherein a feeding point is provided at one end of the first antenna element, and the other end of the first antenna element is connected to the first terminal of the first switch; one of the second terminals of the first switch is connected to one end of the second antenna element via a reactance element, and at least one of the other second terminals is connected to the one end of the second antenna element via a reactance element that is different in reactance value than the former reactance element; and the one end of the first antenna element is grounded to the ground pattern of the circuit board via an inductor, and the ground terminal of the first switch is connected to the other end of the first antenna element. This antenna device can provide three or more resonance frequencies even with the single antenna element because it is equipped with the reactance elements having different reactance values.

The antenna device according to the invention is configured in such a manner that the first switch has a power terminal and a control terminal; and at least one inductor is inserted in each of a power line which connects the power terminal and the circuit board and a control line which connects the control terminal and the circuit board. This antenna device can suppress degradation of the antenna performance that might be caused by the power line or the control line.

The antenna device according to the invention is configured in such a manner that each of the power line and the control line extends close to and approximately parallel with the first antenna element, and the inductor is disposed in the vicinity of the feeding point. This antenna device can suppress degradation of the antenna performance by causing the power line and the control line to operate together with the first antenna element etc.

The antenna device according to the invention is configured in such a manner that the first switch is a MEMS switch. This antenna device can suppress degradation of the antenna performance that is associated with resonance frequency switching because the degree of isolation is high when the first terminal and each second terminal of the switch are disconnected from each other, the insertion loss in a connection state is low, the degree of isolation between the second terminals is high, and the phase variation between the first terminal and each second terminal is small.

The antenna device according to the invention is configured so as to include at least one third antenna element which is spaced from the ground pattern by a prescribed interval; and at least one second switch which has a ground terminal, a first terminal, and at least one second terminal and connects or disconnects the first terminal and each second terminal to or from each other, wherein the first terminal of the second switch is connected to the other end of at least one second antenna element; at least one second terminal of the second switch is connected to one end of the third antenna element directly or via a reactance element; and the one end of the second antenna element is grounded to the ground pattern of the circuit board via the first switch, the first antenna element, and the inductor, and the ground terminal of the second switch is connected to the other end of the second antenna element. This antenna device can accommodate even more resonance frequencies.

### Advantageous of the Invention

As described above, in the antenna devices according to the invention, since an antenna element also serves as a switch ground pattern which is connected to the ground terminal of a switch, the resonance frequency can be switched by varying the electrical length of the antenna element without degrading the antenna performance.

### BRIEF DESCRIPTION OF THE DRAWINGS

FIG. 1 is a schematic diagram of an antenna device according to a first embodiment of the present invention.

FIG. 2 shows, in detail, the other end of a first antenna element of the antenna device according to the first embodiment of the invention.

FIG. 3 is a graph showing reflection characteristics of the antenna device according to the first embodiment of the invention.

FIG. 4 is a schematic diagram of an antenna device according to a second embodiment of the invention.

FIG. 5 is a graph showing reflection characteristics of the antenna device according to the second embodiment of the invention.

FIG. 6 is a schematic diagram of an antenna device according to a third embodiment of the invention.

FIG. 7 is a graph showing reflection characteristics of the antenna device according to the third embodiment of the invention.

FIG. 8 is a schematic diagram of another antenna device according to the third embodiment of the invention.,

FIG. 9 is a schematic diagram of an antenna device according to a fourth embodiment of the invention.

FIG. 10 is a schematic diagram of an antenna device according to a fifth embodiment of the invention.

FIG. 11 is a schematic diagram of an antenna device according to a sixth embodiment of the invention.

FIG. 12 is a schematic diagram of another antenna device according to the sixth embodiment of the invention.

### MODE FOR CARRYING OUT THE INVENTION

Embodiments of the present invention will be hereinafter described with reference to the drawings.

### Embodiment 1

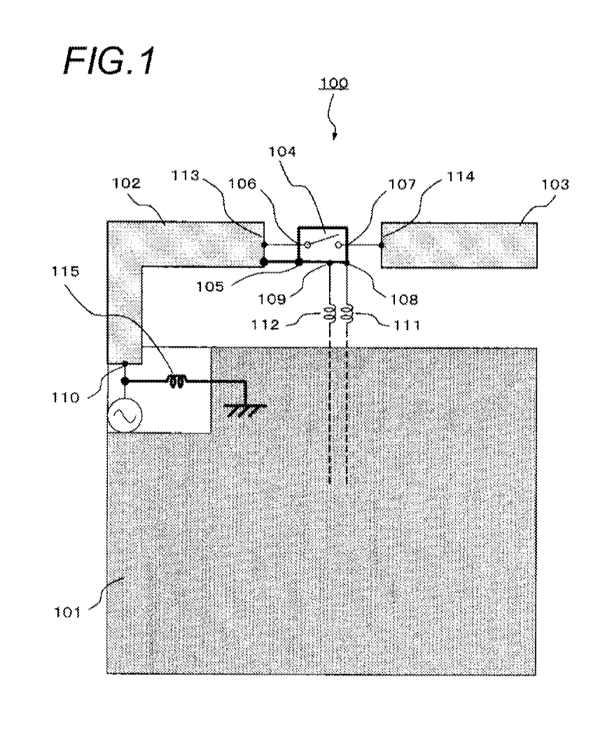

FIG. 1 is a schematic diagram of an antenna device 100 according to a first embodiment of the invention.

The antenna device 100 shown in FIG. 1 is equipped with a circuit board having a ground pattern 101 which covers the almost entire surface of the circuit board, a first antenna element 102 and a second antenna element 103 which are disposed so as to be spaced from the ground pattern 101 by prescribed intervals, and a MEMS switch 104 as a first switch. The MEMS switch 104 has a ground terminal 105, a first terminal 106, a second terminal 107, a power terminal 108, and a control terminal 109. Thus, the MEMS switch 104 is a single-pole single-throw (SPST) switch which switches between a connection state and a disconnection state of the first terminal 106 and the second terminal 107. A feeding point 110 is provided at one end of the first antenna element 102 and is connected to a radio unit (not shown). The power terminal 108 and the control terminal 109 are connected to a control unit (not shown) provided on the circuit board via respective inductors 111 and 112. The other end 113 of the first antenna element 102 is connected to the first terminal 106 of the MEMS switch 104, and one end 114 of the second antenna element 103 is connected to the second terminal 107 of the MEMS switch 104. Furthermore, the one end of the first antenna element 102 is grounded to the ground pattern 101 via an inductor 115, and the ground terminal 105 of the MEMS switch 104 is connected to the other end 113 of the first antenna element 102. The inductance value of the inductor 115 is set so that the influence on the antenna performance is made low at wireless communication frequencies.

In contrast to the schematic diagram of FIG. 1, 2 shows, in detail, a shape of the other end 113 of the first antenna element 102 around the MEMS switch 104.

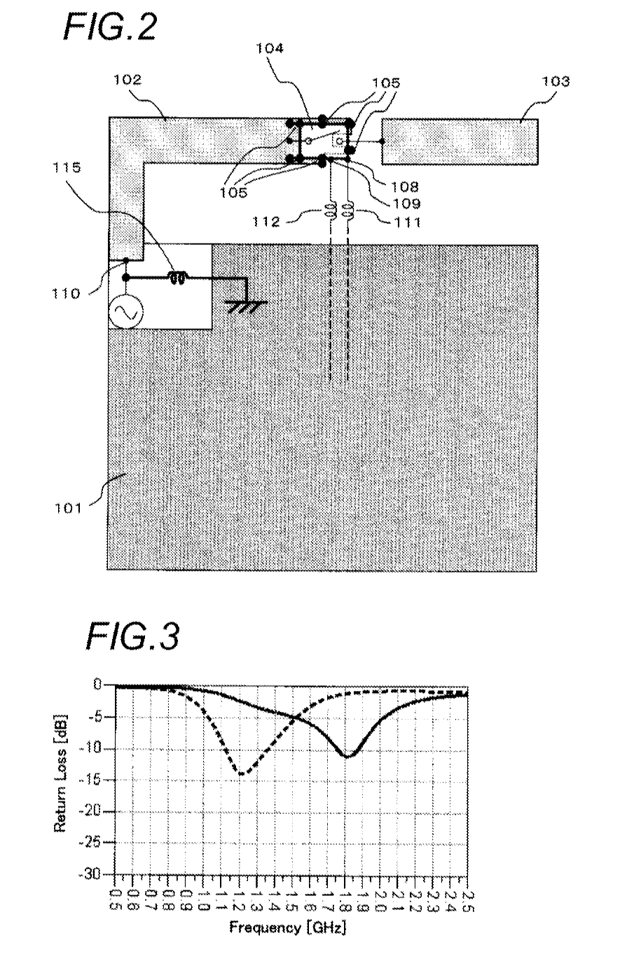

As shown in FIG. 2, the MEMS switch 104 is generally equipped with plural ground terminals 105. Therefore, the other end 113 of the first antenna element 102 is shaped so as to surround the MEMS switch 104 except its second terminal 107, power terminal 108, and control terminal 109.

With the above configuration, the ground terminals 105 of the MEMS switch 104 are grounded to the ground pattern 101 via the first antenna element 102 and the inductor 115. That is, the first antenna element 102 also serves as a switch ground pattern which is connected to the ground terminals 105 of the MEMS switch 104. This prevents a phenomenon that a switch ground pattern is located close to an antenna element to degrade the antenna performance. FIG. 3 shows example antenna reflection characteristics. In FIG. 3, the solid line represents a reflection characteristic in a state that the first terminal 106 and the second terminal 107 of the MEMS switch 104 are disconnected from each other and the broken line represents a reflection characteristic in a state that the first terminal 106 and the second terminal 107 of the MEMS switch 104 are connected to each other. As seen from these characteristics, two resonance frequencies can be obtained by varying the electrical length of the antenna element by switching between the connection state and the disconnection state of the first terminal 106 and the second terminal 107 of the MEMS switch 104 according to wireless communication frequencies.

Two desired resonance frequencies can be obtained by adjusting the electrical lengths of the first antenna element 102 and the second antenna element 103. A similar effect can be obtained by inserting one or more reactance elements between the second terminal 107 of the MEMS switch 104 and the one terminal 114 of the second antenna element 103 for the purpose of fine adjustment of the electrical length of the second antenna element 103. The MEMS switch 104 may be mounted on either the circuit board having the ground pattern 101 or another board (base substrate). Each of the first antenna element 102 and the second antenna element 103 may be a conductor pattern formed on the circuit board having the ground pattern 101 or part of it may be a separate metal sheet. The first switch is not limited to a MEMS switch, and may be a semiconductor switch, for example, as long as it provides high insulation performance in a connected state of the first terminal 106 and the second terminal 107 and a low insertion loss in a disconnected state of them. However, the use of a MEMS switch is desirable from the viewpoint of a small phase variation between the first terminal 106 and the second terminal 107. The inductor 115 may not only serve to ground the ground terminals 105 of the MEMS switch 104 but also serve as part of a matching circuit.

### Embodiment 2

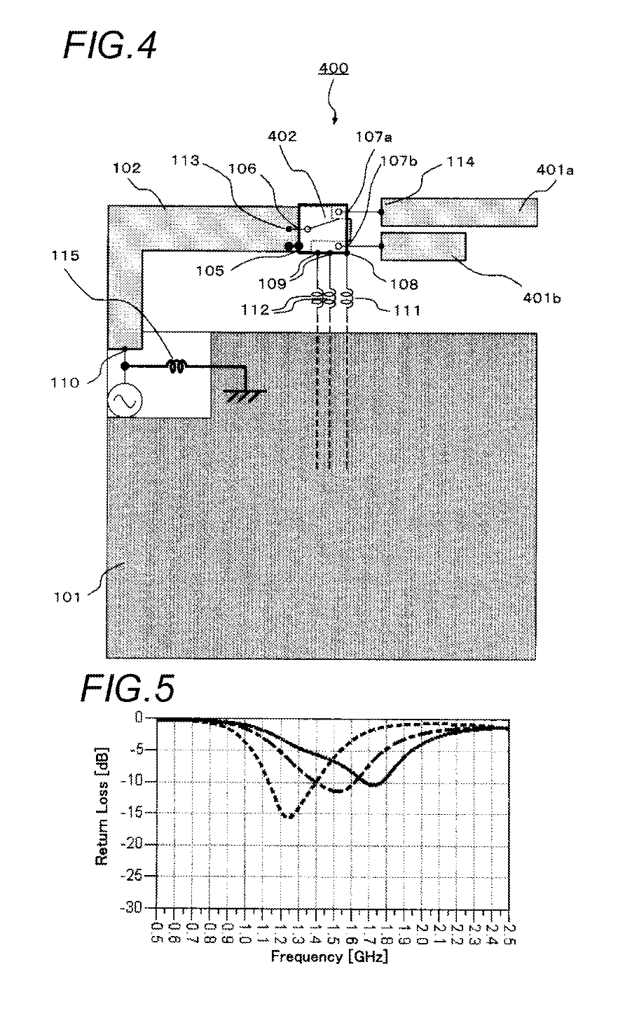

FIG. 4 is a schematic diagram of an antenna device 400 according to a second embodiment of the invention. Members in FIG. 4 having the same ones in FIGS. 1 and 2 are given the same reference symbols as the latter and descriptions therefor will be omitted.

The antenna device 400 shown in FIG. 4 is equipped with two second antenna elements 401a and 401b having different electrical lengths and a MEMS switch 402 as a first switch. In this embodiment, the electrical length of the second antenna element 401a is set longer than that of the second antenna element 401b. The MEMS switch 402 is a single-pole double-throw (SPDT) switch which has two second terminals 107a and 107b and switches between three states, that is, a state that the first terminal 106 is disconnected from both of the second terminals 107a and 107b, a state that the first terminal 106 is connected to the second terminal 107a, and a state that the first terminal 106 is connected to the second terminal 107b. The numbers of control terminals 109 and inductors 112 are increased according to the increase in the number of second terminals.

FIG. 5 shows example reflection characteristics obtained by the above configuration. In FIG. 5, the solid line represents a reflection characteristic in a state that the first terminal 106 is disconnected from both of the second terminals 107a and 107b, the broken line represents a reflection characteristic in a state that the first terminal 106 is connected to the second terminal 107a, and the chain line represents a reflection characteristic in a state that the first terminal 106 is connected to the second terminal 107b. As seen from these characteristics, three resonance frequencies can be obtained by varying the electrical length of the antenna element by switching between the states of the MEMS switch 402.

Although in this embodiment the first switch is an SPDT switch, (n+1) resonance frequencies can be obtained by using an SPnT switch (n=3, 4, 5, . . . ); for example, four resonance frequencies can be obtained by adding a second antenna element whose electrical length is different from those of the second antenna elements 401a and 401b and using an SP3T switch.

### Embodiment 3

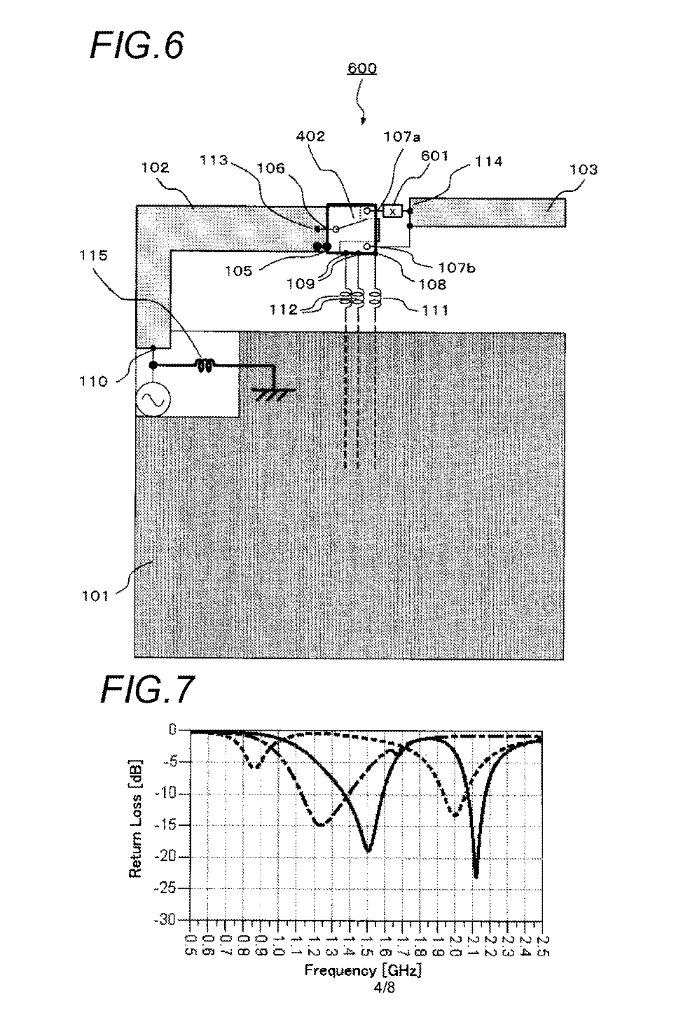

FIG. 6 is a schematic diagram of an antenna device 600 according to a third embodiment of the invention. Members in FIG. 4 having the same ones in FIGS. 1 and 2 or FIG. 4 are given the same reference symbols as the latter and descriptions therefor wilt be omitted.

In the antenna device 600 shown in FIG. 6, although only one second antenna element 103 is provided, a MEMS switch 402 having the SPDT structure is provided as the first switch. A reactance element 601 is inserted between the second terminal 107a and the one end 114 of the second antenna element 103 and the second terminal 107a and the second antenna element 103 are directly connected to each other.

FIG. 7 shows example reflection characteristics of the above configuration in a case that the reactance element 601 is an inductor. In FIG. 7, the solid line represents a reflection characteristic in a state that the first terminal 106 of the MEMS switch 402 is disconnected from both of the second terminals 107a and 107b, the broken line represents a reflection characteristic in a state that the first terminal 106 of the MEMS switch 402 is connected to the second terminal 107a, and the chain line represents a reflection characteristic in a state that the first terminal 106 of the MEMS switch 402 is connected to the second terminal 107b. As seen from these characteristics, three or more resonance frequencies can be obtained by varying the electrical length of the antenna element by switching between the states of the MEMS switch 402.

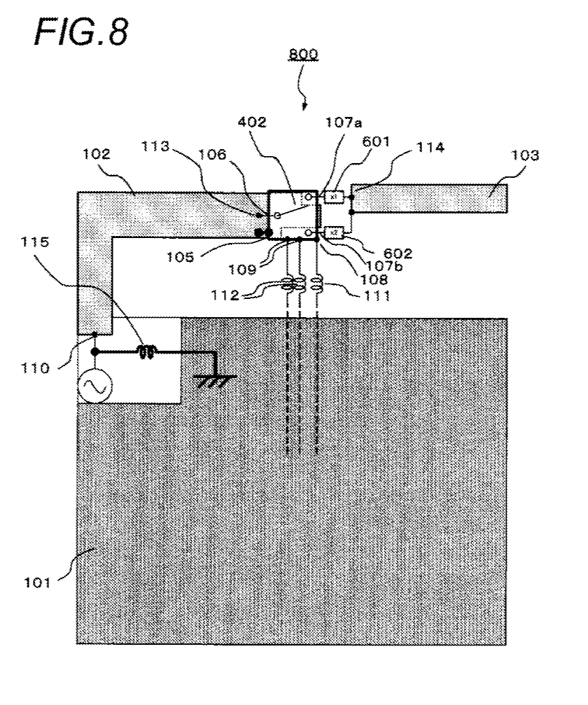

FIG. 8 is a schematic diagram of an antenna device 800 according to the third embodiment of the invention. A similar effect can be obtained by also inserting a reactance element whose reactance value is different from that of the reactance element 601 between the second terminal 107b and the one end 114 of the second antenna element 103 (see FIG. 8). Although in the above configurations the first switch is an SPDT switch, n+1 or more resonance frequencies can be obtained even if the number of second antenna elements 103 is smaller than n by a configuration with an SPnT switch (n=3, 4, 5, . . . ) in which plural reactance elements having different reactance values are provided. Each of the reactance elements for varying the frequency characteristic is not limited to a single inductor or capacitor and may be a combination of a reactor and a capacitor.

### Embodiment 4

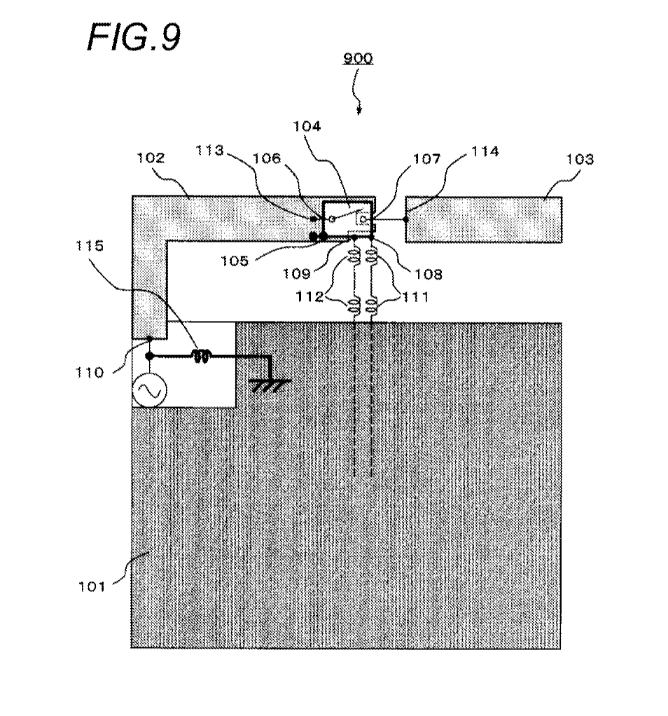

FIG. 9 is a schematic diagram of an antenna device 900 according to a fourth embodiment of the invention. Members in FIG. 9 having the same ones in FIGS. 1 and 2 are given the same reference symbols as the latter and descriptions therefor will be omitted.

In the antenna device 100 shown in FIG. 1, the power terminal 108 and the control terminal 109 are connected to the control unit (not shown) on the circuit board via the single inductor 111 and the single inductor 112, respectively. In contrast, in the antenna device 900 shown in FIG. 9, two inductors 111 and two inductors 112 are inserted in such a manner that one of the inductors 111 or the inductors 112 is disposed in the vicinity of the ground pattern 101 and the other is disposed in the vicinity of the MEMS switch 104.

In the above configuration, the power line and the control line are disconnected at high frequencies. This makes it possible to suppress a phenomenon that a frequency band occurs in which the antenna performance is degraded depending on the electrical length of the power line or the control line.

Inserting even one inductor in each of the power line and the control line has a pronounced effect as compared to a case that no inductor is inserted. Where the power line and the control line are long, it is desirable to insert an inductor between the two ends of each of them. It is desirable to wire the power line and the control line so that they are not close to the second antenna element 103.

### Embodiment 5

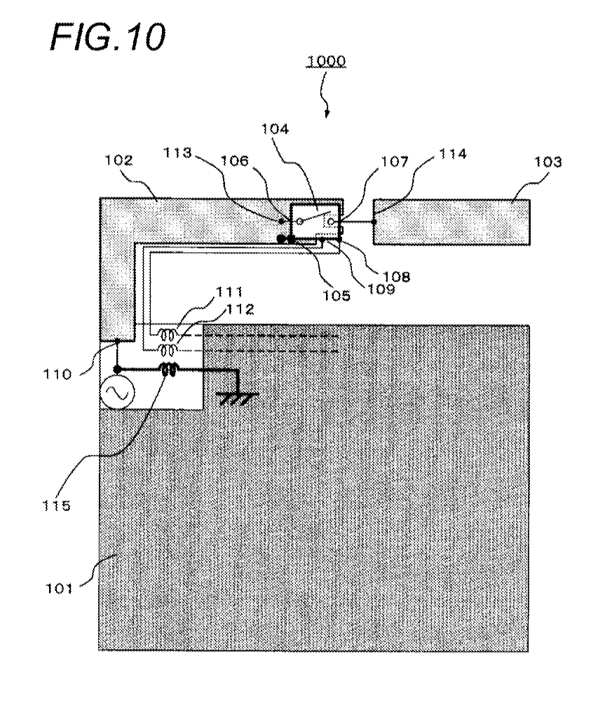

FIG. 10 is a schematic diagram of an antenna device 1000 according to a fifth embodiment of the invention. Members in FIG. 10 having the same ones in FIGS. 1 and 2 are given the same reference symbols as the latter and descriptions therefor will be omitted.

In the antenna device 1000 shown in FIG. 10, each line of the power line extending from the power terminal 108 of the MEMS switch 104 to the inductor 111 and the control line extending from the control terminal 107 of the MEMS switch 104 to the inductor 112 is wired close to and approximately parallel with the first antenna element 102. The inductors 111 and 112 are disposed adjacent to each other and in the vicinity of the feeding point 110.

The above configuration makes it possible to suppress degradation of the antenna performance by causing the power line and the control line which might degrade the antenna performance to operate together with the first antenna element 102.

To disconnect the ground pattern 101 and the first antenna element 102 at high frequencies, it is desirable to dispose the inductors 111 and 112 adjacent to the inductor 115.

The power line and the control line are not necessarily disposed in the same plane as the first antenna element 102; they may be disposed on the back side of the first antenna element 102 using a multilayer board.

### Embodiment 6

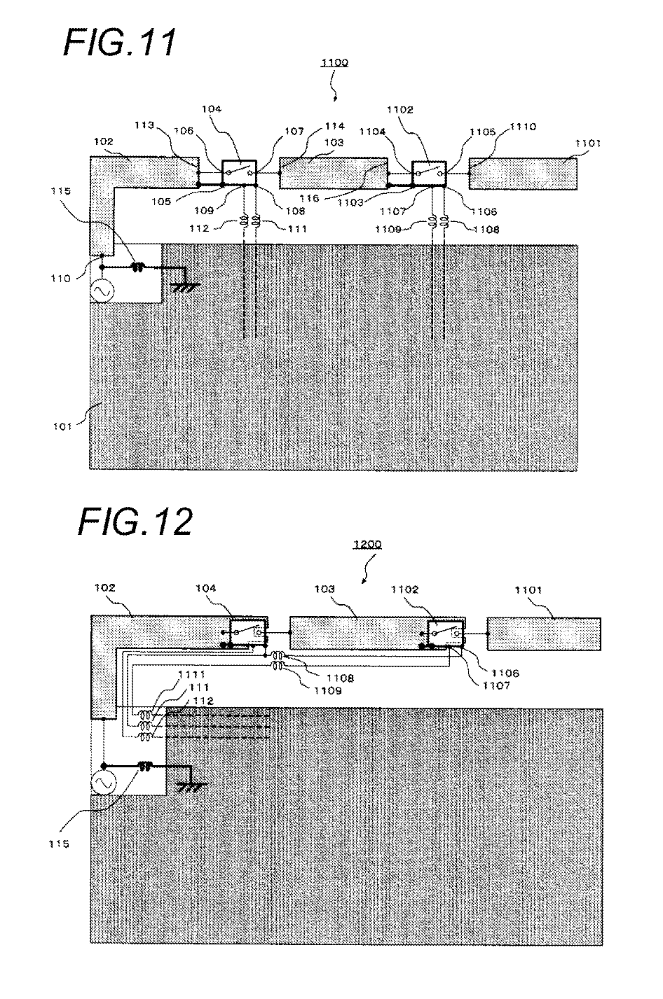

FIG. 11 is a schematic diagram of an antenna device 1100 according to a sixth embodiment of the invention. Members in FIG. 11 having the same ones in FIGS. 1 and 2 are given the same reference symbols as the latter and descriptions therefor will be omitted.

The antenna device 1100 shown in FIG. 11 is equipped with a third antenna element 1101 which is spaced from the ground pattern 101 by a prescribed interval and a MEMS switch 1102 as a second switch. Like the MEMS switch 104, the MEMS switch 1102 is an SPST switch which has a ground terminal(s) 1103, a first terminal 1104, a second terminal 1105, a power terminal 1106, and a control terminal 1107 and switches between a connection state and a disconnection state of the first terminal 1104 and the second terminal 1105. The power terminal 1106 and the control terminal 1107 are connected to a control unit (not shown) provided on the circuit board via respective inductors 1108 and 1109. The other end 116 of the second antenna element 103 is connected to the first terminal 1104 of the MEMS switch 1102, and one end 1110 of the third antenna element 1101 is connected to the second terminal 1105 of the MEMS switch 1102. The ground terminal(s) 1103 of the MEMS switch 1102 is connected to the other end 116 the second antenna element 103.

With the above configuration, in a state that the first terminal 106 and the second terminal 107 of the MEMS switch 104 are connected to each other, the ground terminal(s) 1103 of the MEMS switch 1102 is grounded to the ground pattern 101 via the second antenna element 103, the MEMS switch 104, the first antenna element 102, and the inductor 115. That is, the second antenna element 103 also serves as a switch ground pattern which is connected to the ground terminal(s) 1103 of the MEMS switch 1102. This prevents a phenomenon that a switch ground pattern is located close to an antenna element to degrade the antenna performance. Furthermore, three resonance frequencies can be obtained by adjusting the electrical lengths of the antenna elements by switching between the connection state and the disconnection state of the first terminal 106 and the second terminal 107 of the MEMS switch 104 and the connection state and the disconnection state of the first terminal 1104 and the second terminal 1105 of the MEMS switch 1102 according to wireless communication frequencies.

In a state that the first terminal 106 and the second terminal 107 of the MEMS switch 104 are disconnected from each other, the resonance frequency is determined by the first antenna element 102 which is a dominant antenna element, the fact that the ground terminal(s) 1103 of the MEMS switch 1102 is not grounded to the ground pattern 101 does not cause any problems. Even more resonance frequencies can be obtained by plural second antenna elements and plural third antenna elements or employing SPOT switches or SPnT switches (n=3, 4, 5, . . . ) as the MEMS switches 104 and 1102.

Where the power line an the control line of the MEMS switch 1102 are wired close to and approximately parallel with the second antenna element 103 and the first antenna element 102, as shown in FIG. 12 the inductors 1108 and 1109 are disposed adjacent to the boundary between the first antenna element 102 and the second antenna element 103. The power line is shared by the MEMS switches 104 and 1102. For the control lines, an inductor 1111 is added so as to be disposed adjacent to the inductors 111 and 112. As a result, degradation of the antenna performance can be suppressed by causing the power line and the control lines which might degrade the antenna performance to operate together with the first antenna element 102 and the second antenna element 103.

Although the invention has been described in detail by referring to the particular embodiments, it is apparent to those skilled in the art that various changes and modifications are possible without departing from the spirit and scope of the invention.

The present application is based on Japanese Patent Application No. 2011-127889 filed on Jun. 8, 2011, the disclosure of which is incorporated herein by reference.

### INDUSTRIAL APPLICABILITY

Since an antenna element also serves as a switch ground pattern which is connected to the ground terminal of a switch, a phenomenon that a switch ground pattern is located close to an antenna element to degrade the antenna performance is prevented. And the resonance frequency can be switched by varying the electrical length of the antenna element according to a wireless communication frequency. As such, the invention is useful when applied to cellphones, smartphones. etc.

### DESCRIPTION OF SYMBOLS

100, 400, 600, 800, 900, 1000, 1100: Antenna device

101: Ground pattern

102: First antenna element

103, 401a, 401b: Second antenna element

104, 402: MEMS switch (first switch)

105, 1103: Ground terminal

106, 1104: First terminal

107, 107a, 107b, 1105: Second terminal

108, 1106: Power terminal

109, 1107: Control terminal

110: Feeding point

111, 112, 115, 1108, 1109, 1111: Inductor

601, 602: Reactance element

1101: Third antenna element

1102: MEMS switch (second switch)

1. An antenna device comprising:
a circuit board having a ground pattern;
a first antenna element and a second antenna element which are disposed so as to be spaced from the ground pattern by prescribed intervals; and
a first switch which has a ground terminal, a first terminal, and a second terminal and connects or disconnects the first terminal and the second terminal to or from each other,
wherein a feeding point is provided at one end of the first antenna element, and the other end of the first antenna element is connected to the first terminal of the first switch;
wherein one end of the second antenna element is connected to the second terminal of the first switch; and
wherein the one end of the first antenna element is grounded to the ground pattern of the circuit board via an inductor, and the ground terminal of the first switch is connected to the other end of the first antenna element.

2. An antenna device comprising:
a circuit board having a ground pattern;
a first antenna element and plural second antenna elements which are disposed so as to be spaced from the ground pattern by prescribed intervals, the plural second antenna elements having different electrical lengths to each other; and
a first switch which has a ground terminal, a first terminal, and plural second terminals and connects or disconnects the first terminal and each of the second terminals to or from each other,
wherein a feeding point is provided at one end of the first antenna element, and the other end of the first antenna element is connected to the first terminal of the first switch;
wherein one ends of the second antenna elements are connected to the respective second terminals of the first switch; and
wherein the one end of the first antenna element is grounded to the ground pattern of the circuit board via an inductor, and the ground terminal of the first switch is connected to the other end of the first antenna element.

3. An antenna device comprising:
a circuit board having a ground pattern;
a first antenna element and a second antenna element which are disposed so as to be spaced from the ground pattern by prescribed intervals; and
a first switch which has a ground terminal, a first terminal, and plural second terminals and connects or disconnects the first terminal and each of the second terminals to or from each other,
wherein a feeding point is provided at one end of the first antenna element, and the other end of the first antenna element is connected to the first terminal of the first switch;
wherein one of the second terminals of the first switch is connected to one end of the second antenna element, and at least one of the other second terminals is connected to the one end of the second antenna element via a reactance element; and
wherein the one end of the first antenna element is grounded to the ground pattern of the circuit board via an inductor, and the ground terminal of the first switch is connected to the other end of the first antenna element.

4. An antenna device comprising:
a circuit board having a ground pattern;
a first antenna element and a second antenna element which are disposed so as to be spaced from the ground pattern by prescribed intervals; and
a first switch which has a ground terminal, a first terminal, and plural second terminals and connects or disconnects the first terminal and each of the second terminals to or from each other,
wherein a feeding point is provided at one end of the first antenna element, and the other end of the first antenna element is connected to the first terminal of the first switch;
wherein one of the second terminals of the first switch is connected to one end of the second antenna element via a reactance element, and at least one of the other second terminals is connected to the one end of the second antenna element via a reactance element that is different in reactance value than the former reactance element; and
wherein the one end of the first antenna element is grounded to the ground pattern of the circuit board via an inductor, and the ground terminal of the first switch is connected to the other end of the first antenna element.

5. The antenna device according to claim 1, wherein the first switch has a power terminal and a control terminal; and
wherein at least one inductor is inserted in each of a power line which connects the power terminal and the circuit board and a control line which connects the control terminal and the circuit board.

6. The antenna device according to claim 5, wherein each of the power line and the control line extends close to and approximately parallel with the first antenna element, and the inductor is disposed in the vicinity of the feeding point.

7. The antenna device according to claim 1, wherein the first switch is a MEMS (micro-electromechanical system) switch.

8. The antenna device according to claim 1, further comprising:
at least one third antenna element which is disposed so as to be spaced from the ground pattern by a prescribed interval; and
at least one second switch which has a ground terminal, a first terminal, and at least one second terminal and connects or disconnects the first terminal and each second terminal to or from each other,
wherein the first terminal of the second switch is connected to the other end of the second antenna element;
wherein at least one second terminal of the second switch is connected to one end of the third antenna element directly or via a reactance element; and
wherein the one end of the second antenna element is grounded to the ground pattern of the circuit board via the first switch, the first antenna element, and the inductor, and the ground terminal of the second switch is connected to the other end of the second antenna element.

9. The antenna device according to claim 2, wherein the first switch has a power terminal and a control terminal; and
wherein at least one inductor is inserted in each of a power line which connects the power terminal and the circuit board and a control line which connects the control terminal and the circuit board.

10. The antenna device according to claim 9, wherein each of the power line and the control line extends close to and approximately parallel with the first antenna element, and the inductor is disposed in the vicinity of the feeding point.

11. The antenna device according to claim 2, wherein the first switch is a MEMS (micro-electromechanical system) switch.

12. The antenna device according to claim 2, further comprising:
at least one third antenna element which is disposed so as to be spaced from the ground pattern by a prescribed interval; and
at least one second switch which has a ground terminal, a first terminal, and at least one second terminal and connects or disconnects the first terminal and each second terminal to or from each other,
wherein the first terminal of the second switch is connected to the other end of at least one of the second antenna elements;
wherein at least one second terminal of the second switch is connected to one end of the third antenna element directly or via a reactance element; and
wherein the one end of the second antenna element is grounded to the ground pattern of the circuit board via the first switch, the first antenna element, and the inductor, and the ground terminal of the second switch is connected to the other end of the second antenna element.

13. The antenna device according to claim 3, wherein the first switch has a power terminal and a control terminal; and
wherein at least one inductor is inserted in each of a power line which connects the power terminal and the circuit board and a control line which connects the control terminal and the circuit board.

14. The antenna device according to claim 13, wherein each of the power line and the control line extends close to and approximately parallel with the first antenna element, and the inductor is disposed in the vicinity of the feeding point.

15. The antenna device according to claim 3, wherein the first switch is a MEMS (micro-electromechanical system) switch.

16. The antenna device according to claim 3, further comprising:
at least one third antenna element which is disposed so as to be spaced from the ground pattern by a prescribed interval; and
at least one second switch which has a ground terminal, a first terminal, and at least one second terminal and connects or disconnects the first terminal and each second terminal to or from each other,
wherein the first terminal of the second switch is connected to the other end of the second antenna element;
wherein at least one second terminal of the second switch is connected to one end of the third antenna element directly or via a reactance element; and
wherein the one end of the second antenna element is grounded to the ground pattern of the circuit board via the first switch, the first antenna element, and the inductor, and the ground terminal of the second switch is connected to the other end of the second antenna element.

17. The antenna device according to claim 4, wherein the first switch has a power terminal and a control terminal; and
wherein at least one inductor is inserted in each of a power line which connects the power terminal and the circuit board and a control line which connects the control terminal and the circuit board.

18. The antenna device according to claim 17, wherein each of the power line and the control line extends close to and approximately parallel with the first antenna element, and the inductor is disposed in the vicinity of the feeding point.

19. The antenna device according to claim 4, wherein the first switch is a MEMS (micro-electromechanical system) switch.

20. The antenna device according to claim 4, further comprising:
at least one third antenna element which is disposed so as to be spaced from the ground pattern by a prescribed interval; and
at least one second switch which has a ground terminal, a first terminal, and at least one second terminal and connects or disconnects the first terminal and each second terminal to or from each other,
wherein the first terminal of the second switch is connected to the other end of the second antenna element;
wherein at least one second terminal of the second switch is connected to one end of the third antenna element directly or via a reactance element; and
wherein the one end of the second antenna element is grounded to the ground pattern of the circuit board via the first switch, the first antenna element, and the inductor, and the ground terminal of the second switch is connected to the other end of the second antenna element.
